(19) United States
(12) Patent Application Publication
(10) Pub. No.: US 2025/0078528 A1
(43) Pub. Date: Mar. 6, 2025

(54) TRAFFIC LIGHT IDENTIFICATION DEVICE FOR HOST VEHICLE, HOST VEHICLE, TRAFFIC LIGHT IDENTIFICATION METHOD FOR HOST VEHICLE, AND NON-TRANSITORY RECORDING MEDIUM

(71) Applicant: TOYOTA JIDOSHA KABUSHIKI KAISHA, Toyota-shi Aichi-ken (JP)

(72) Inventor: Takahiro Maeda, Edogawa-ku Tokyo-to (JP)

(73) Assignee: TOYOTA JIDOSHA KABUSHIKI KAISHA, Toyota-shi Aichi-ken (JP)

(21) Appl. No.: 18/595,732

(22) Filed: Mar. 5, 2024

(30) Foreign Application Priority Data
Mar. 7, 2023 (JP) 2023-034838

(51) Int. Cl. G06V 20/58; B60W 30/18; B60W 40/08; B60W 50/14; G06V 10/70; G06V 20/59; G06V 40/16

(52) U.S. Cl. CPC G06V 20/584; B60W 30/18159; B60W 40/08; B60W 50/14; G06V 10/70; G06V 20/597; G06V 40/161; B60W 2040/0818; B60W 2050/143; B60W 2050/146; B60W 2420/403; B60W 2540/12; B60W 2540/225; B60W 2540/229; B60W 2555/60

(57) ABSTRACT

A traffic light identification device for a host vehicle identifies a traffic light existing at a driver gaze position among a plurality of traffic lights included in a front camera image as a traffic light for the host vehicle, when the preceding vehicle does not exist in front of the host vehicle, when the host vehicle is entering an intersection, and when a braking operation by a driver is detected.

### CROSS-REFERENCE TO RELATED APPLICATIONS

This application claims priority to Japanese Patent Application No. 2023-034838 filed on Mar. 7, 2023, the entire contents of which are herein incorporated by reference.

### FIELD

The present disclosure relates to traffic light identification device for a host vehicle, the host vehicle, traffic light identification method for the host vehicle, and non-transitory recording medium.

### BACKGROUND

PTL 1 (Japanese Unexamined Patent Publication No. 2020-166396) discloses art performing driving support to a driver of a vehicle which is about to enter an intersection. In the art described in PTL 1, when the driver of the vehicle which is about to enter the intersection tries to for example turn right at the intersection, a driving support system for the vehicle determines whether the vehicle can pass through the intersection obeying a right turn traffic light or the vehicle has to stop once at the intersection obeying a stop signal (stop traffic light) before passing through the intersection obeying the right turn traffic light and conveys determination result to the driver as the driving support. On the other hand, in the art described in PTL 1, a front camera image captured by a front camera mounted on the vehicle is not used for identifying a traffic light which the vehicle should obey.

A front camera image sometimes includes traffic lights other than the traffic light which the host vehicle should obey. For example, in order to perform the driving support notifying the driver of a change of display of a traffic light which the host vehicle should obey etc. based on a front camera image, art is necessary for suitably identifying the traffic light which the host vehicle should obey among a plurality of traffic lights included in the front camera image.

### SUMMARY

In consideration of the above, the present disclosure has an object for providing traffic light identification device for a host vehicle, the host vehicle, traffic light identification method for the host vehicle, and non-transitory recording medium which can suitably identify a traffic light for the host vehicle which the host vehicle should obey among a plurality of traffic lights included in a front camera image.

(1) One aspect of the present disclosure is a traffic light identification device for a host vehicle having a processor configured to: identify a driver gaze position that is a position on a front camera image captured by a front camera corresponding to a position in front of the host vehicle which a driver of the host vehicle is gazing at based on a positional relationship between a driver monitor camera and the front camera and a driver monitor camera image including a face of the driver captured by the driver monitor camera; detect at least one traffic light included in the front camera image; identify a traffic light for the host vehicle that is a traffic light which the host vehicle should obey among a plurality of traffic lights when the plurality of traffic lights included in the front camera image is detected; determine whether the host vehicle is entering an intersection; determine whether a preceding vehicle exists in front of the host vehicle; and detect a braking operation by the driver, wherein the processor identifies a traffic light existing at the driver gaze position among the plurality of traffic lights included in the front camera image as the traffic light for the host vehicle, when the preceding vehicle does not exist in front of the host vehicle, when the host vehicle is entering the intersection, and when the braking operation by the driver is detected.

(2) In the host vehicle comprising the traffic light identification device for the host vehicle according to aspect (1) and a warning device, a processor provided in the warning device may be configured to determine whether a display of the traffic light for the host vehicle changed from a red light to a blue light or a green light; determine whether the driver depressed an accelerator pedal before a predetermined time elapses from the time point when the display of the traffic light for the host vehicle changed from the red light to the blue light or the green light; and perform processing for outputting a warning when the driver did not depress the accelerator pedal before the predetermined time elapses from the time point when the display of the traffic light for the host vehicle changed from the red light to the blue light or the green light.

(3) In the host vehicle comprising the traffic light identification device for the host vehicle according to aspect (1) and a communication device, the communication device may be configured to send data of the front camera image and information showing the traffic light for the host vehicle included in the front camera image identified by the processor of the traffic light identification device for the host vehicle to a server device, the server device may be configured to perform machine learning of a machine learning model for estimating a traffic light for an autonomous vehicle that is a traffic light which is included in an image captured by a front camera mounted on the autonomous vehicle and which the autonomous vehicle should obey, and data of the front camera image sent by the communication device and the information showing the traffic light for the host vehicle included in the front camera image identified by the processor of the traffic light identification device for the host vehicle may be used as correct answer data in the machine learning of the machine learning model.

(4) An aspect of the present disclosure is a traffic light identification method for a host vehicle having: identifying a driver gaze position that is a position on a front camera image captured by a front camera corresponding to a position in front of the host vehicle which a driver of the host vehicle is gazing at based on a positional relationship between a driver monitor camera and the front camera and a driver monitor camera image including a face of the driver captured by the driver monitor camera; detecting at least one traffic light included in the front camera image; identifying a traffic light for the host vehicle that is a traffic light which the host vehicle should obey among a plurality of traffic lights when the plurality of traffic lights included in the front camera image is detected; determining whether the host vehicle is entering an intersection; determining whether a preceding vehicle exists in front of the host vehicle; and detecting a braking operation by the driver, wherein a traffic light existing at the driver gaze position among the plurality of traffic lights included in the front camera image is identified as the traffic light for the host vehicle, when the preceding vehicle does not exist in front of the host vehicle, when the host vehicle is entering the intersection, and when the braking operation by the driver is detected.

(5) An aspect of the present disclosure is a non-transitory recording medium having recorded thereon a computer program for causing a processor to execute a process having: identifying a driver gaze position that is a position on a front camera image captured by a front camera corresponding to a position in front of a host vehicle which a driver of the host vehicle is gazing at based on a positional relationship between a driver monitor camera and the front camera and a driver monitor camera image including a face of the driver captured by the driver monitor camera; detecting at least one traffic light included in the front camera image; identifying a traffic light for the host vehicle that is a traffic light which the host vehicle should obey among a plurality of traffic lights when the plurality of traffic lights included in the front camera image is detected; determining whether the host vehicle is entering an intersection; determining whether a preceding vehicle exists in front of the host vehicle; and detecting a braking operation by the driver, wherein a traffic light existing at the driver gaze position among the plurality of traffic lights included in the front camera image is identified as the traffic light for the host vehicle, when the preceding vehicle does not exist in front of the host vehicle, when the host vehicle is entering the intersection, and when the braking operation by the driver is detected.

According to the present disclosure, it is possible to suitably identify a traffic light for a host vehicle which the host vehicle should obey among a plurality of traffic lights included in a front camera image.

### BRIEF DESCRIPTION OF DRAWINGS

FIG. 1 is a view showing one example of the schematic configuration of a host vehicle 1 to which a traffic light identification device 20 for the host vehicle 1 of a first embodiment is applied.

FIG. 2 is a view showing one example of the specific configuration of the traffic light identification device 20 for the host vehicle 1 shown in FIG. 1.

FIG. 3 is a view showing one example of the specific configuration of a warning device 30 shown in FIG. 1.

FIG. 4 is a view showing one example of a front camera image G2 including a plurality of traffic lights T01 to T04 captured by a front camera 2.

FIG. 5 is a view showing one example of a driver gaze position G2P on the front camera image G2 identified by a gaze position identifying part 232.

FIG. 6 is a view showing another example of the driver gaze position G2P on the front camera image G2 identified by the gaze position identifying part 232.

FIG. 7 is a flow chart for explaining one example of processing performed by a processor 23 of the traffic light identification device 20 for the host vehicle 1 of the first embodiment.

FIG. 8 is a flow chart for explaining one example of processing performed by a processor 33 of the warning device 30 shown in FIG. 3.

FIG. 9 is a view showing one example of a data collection system SM including the host vehicle 1 to which the traffic light identification device 20 for the host vehicle 1 of the second embodiment is applied and a server device SV.

### DESCRIPTION OF EMBODIMENTS

Below, referring to the drawings, embodiments of traffic light identification device for a host vehicle, the host vehicle, traffic light identification method for the host vehicle, and non-transitory recording medium of the present disclosure will be explained.

### <First Embodiment>

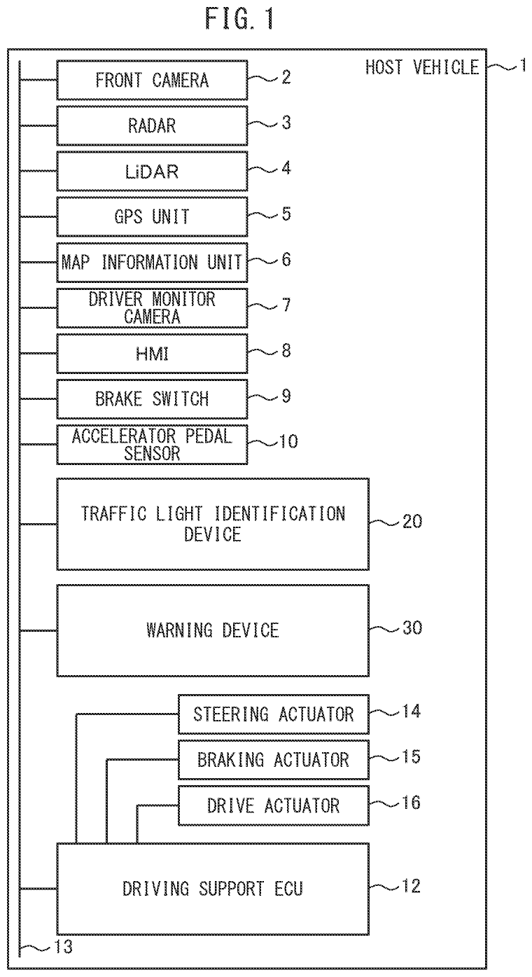

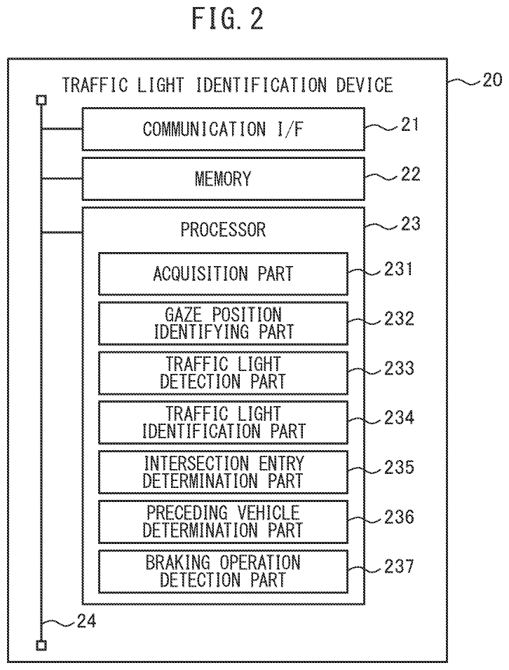

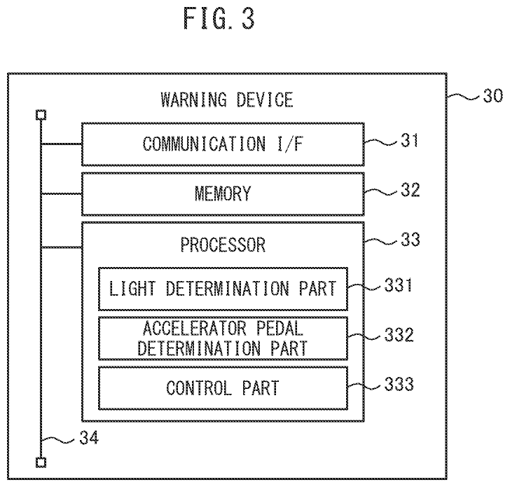

FIG. 1 is a view showing one example of the schematic configuration of a host vehicle 1 to which a traffic light identification device 20 for the host vehicle 1 of a first embodiment is applied. FIG. 2 is a view showing one example of the specific configuration of the traffic light identification device 20 for the host vehicle 1 shown in FIG. 1. FIG. 3 is a view showing one example of the specific configuration of a warning device 30 shown in FIG. 1.

In the example shown in FIGS. 1 to 3, the host vehicle 1 is provided with a front camera 2, a radar 3, a LiDAR (light detection and ranging) device 4, a driving support ECU (electronic control unit) 12, the traffic light identification device 20 for the host vehicle 1, and the warning device 30. The front camera 2 captures images of a nearby vehicle of the host vehicle 1 (for example a preceding vehicle etc.) and the road environment in the vicinity of the host vehicle 1 (for example traffic lights, road structure, rules, etc.) and generates image data showing the nearby vehicle and road environment of the vicinity and sends them to the driving support ECU 12, the traffic light identification device 20 for the host vehicle 1, and the warning device 30. The radar 3 is, for example, a millimeter wave radar, detects a relative position and a relative speed of the nearby vehicle and the road structure in the vicinity with respect to the host vehicle 1, and sends the detection result to the driving support ECU 12 and the warning device 30. The LiDAR 4 detects the relative position and the relative speed of the nearby vehicle and the road structure in the vicinity with respect to the host vehicle 1 and sends the detection result to the driving support ECU 12.

Further, the host vehicle 1 is provided with a GPS (global positioning system) unit 5 and a map information unit 6. The GPS unit 5 acquires positional information showing the current position of the host vehicle 1 based on the GPS signal and sends the positional information of the host vehicle 1 to the driving support ECU 12. The map information unit 6 is formed in storage such as HDD (hard disk drive), SSD (solid state drive), or the like mounted on the host vehicle 1. The map information held by the map information unit 6 includes the road structure (position of the road, shape of the road, lane structure, etc.), rules, and various other types of information.

Furthermore, the host vehicle 1 is provided with a driver monitor camera 7 and HMI (Human Machine Interface) 8. The driver monitor camera 7 captures a driver monitor camera image including the face of the driver of the host vehicle 1. The driver monitor camera 7 is arranged at a top part of a steering column (not shown) of the host vehicle 1 so as to be able to capture the face and a part of the upper body of the driver of the host vehicle 1.

In other examples, the driver monitor camera 7 may be arranged at a center cluster of the host vehicle 1 or the driver monitor camera 7 may be arranged at a room mirror, an instrument panel, an instrument hood, etc. of the host vehicle 1. In these examples, the driver monitor camera 7 can capture the face and the part of the upper body of the driver of the host vehicle 1.

In the example shown in FIGS. 1 to 3, the HMI 8 is an interface for input and output of information between the driving support ECU 12, the warning device 30, etc. and the driver. The HMI 8 is provided with an information device for providing various information to the driver, specifically a display showing text, images, etc., a speaker outputting audio, etc. Further, the HMI 8 is provided with operating buttons, a touch panel, etc. receiving input operations of the driver.

Further, the host vehicle 1 is provided with a brake switch 9 and accelerator pedal sensor 10. The brake switch 9 detects presence or absence of operation of a brake pedal (not shown) by the driver of the host vehicle 1 and sends the detection result to the traffic light identification device 20 for the host vehicle 1. The accelerator pedal sensor 10 is also called, for example, an accelerator operation amount sensor, an accelerator position sensor or the like, detects operation amount of an accelerator pedal (not shown) by the driver of the host vehicle 1, and sends the detection result to the warning device 30.

The front camera 2, the radar 3, the LiDAR 4, the GPS unit 5, the map information unit 6, the driver monitor camera 7, the HMI 8, the brake switch 9, the accelerator pedal sensor 10, the driving support ECU 12, the traffic light identification device 20 for the host vehicle 1, and the warning device 30 are connected through an internal vehicle network 13.

Further, the host vehicle 1 is provided with a steering actuator 14, a braking actuator 15, and a drive actuator 16. The steering actuator 14 includes, for example, a power steering system, a steer-by-wire steering system, a rear wheel steering system or the like. The braking actuator 15 has a function of making the host vehicle 1 decelerate. The braking actuator 15 includes, for example, a hydraulic brake, an electric power regeneration brake or the like. The drive actuator 16 has a function of making the host vehicle 1 accelerate. The drive actuator 16 includes, for example, an engine, an EV (electric vehicle) system, a hybrid system, a fuel cell system or the like.

The driving support ECU 12 sends a control signal for making the steering actuator 14 operate to the steering actuator 14, sends a control signal for making the braking actuator 15 operate to the braking actuator 15, and sends a control signal for making the drive actuator 16 operate to the drive actuator 16.

The traffic light identification device 20 for the host vehicle 1 identifies a traffic light TX for the host vehicle 1 that is a traffic light which the host vehicle 1 should obey among a plurality of traffic lights included in a front camera image G2 captured by the front camera 2.

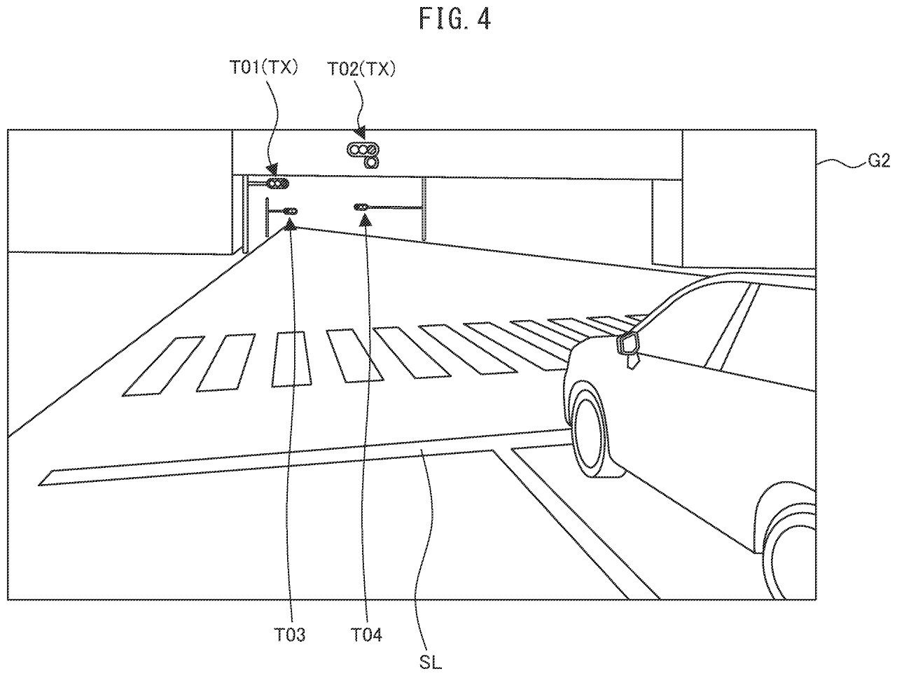

FIG. 4 is a view showing one example of the front camera image G2 including a plurality of traffic lights T01 to T04 captured by the front camera 2.

In the example shown in FIG. 4, four traffic lights T01 to T04 are included in the front camera image G2. The traffic light T01 and traffic light T02 display red lights while the traffic light T03 and traffic light T04 display blue lights (or green lights). The traffic light T01 and traffic light T02 among the traffic lights T01 to T04 are the traffic lights TX for the host vehicle 1 which the host vehicle 1 should obey, while the traffic light T03 and traffic light T04 are traffic lights which the host vehicle 1 does not have to obey. That is, the state shown in FIG. 4 is a state in which the host vehicle 1 has to stop before the stop line SL (lower side of FIG. 4) in accordance with the traffic light TX for the host vehicle 1 (traffic light T01 or traffic light T02) showing a red light.

If the traffic light identification device 20 for the host vehicle 1 were to end up not identifying either of the traffic light T01 and traffic light T02 but identifying either of the traffic light T03 and traffic light T04 as the traffic light TX for the host vehicle 1, in the host vehicle 1, driving support would be liable to be unable to be suitably provided to the driver.

In consideration of this point, in the traffic light identification device 20 for the host vehicle 1 of the first embodiment, the countermeasures explained later are applied so as to enable the traffic light identification device 20 for the host vehicle 1 to suitably identify the traffic light TX for the host vehicle 1 (traffic light T01 or traffic light T02) which the host vehicle 1 should obey among the plurality of traffic lights T01 to T04 included in the front camera image G2.

In the example shown in FIGS. 1 to 3, the traffic light identification device 20 for the host vehicle 1 is comprised of a microcomputer provided with communication interface (I/F) 21, memory 22, and processor 23. The communication interface 21, the memory 22, and the processor 23 are connected via signal lines 24. The communication interface 21 has an interface circuit for connecting the traffic light identification device 20 for the host vehicle 1 to the internal vehicle network 13. The memory 22 has, for example, a volatile semiconductor memory and nonvolatile semiconductor memory. The memory 22 stores a program used in the processing performed by the processor 23 and various types of data. The processor 23 has the function of identifying the traffic light TX for the host vehicle 1 included in the front camera image G2.

In the example shown in FIGS. 1 to 3, the traffic light identification device 20 for the host vehicle 1 is provided with a single processor 23, but in another example, the traffic light identification device 20 for the host vehicle 1 may also be provided with a plurality of processors. Further, in the example shown in FIGS. 1 to 3, the traffic light identification device 20 for the host vehicle 1 is comprised of a single ECU (for example traffic light identification ECU for the host vehicle 1), but in another example, the traffic light identification device 20 for the host vehicle 1 may be comprised of a plurality of ECUs (for example traffic light identification ECU for the host vehicle 1, driving support ECU, warning ECU, etc.)

In the example shown in FIGS. 1 to 3, the processor 23 has a function as an acquisition part 231, a function as a gaze position identifying part 232, a function as a traffic light detection part 233, a function as a traffic light identification part 234 for the host vehicle 1, a function as an intersection entry determination part 235, a function as a preceding vehicle determination part 236, and a function as a braking operation detection part 237.

The acquisition part 231 acquires data of the front camera image G2 including the plurality of traffic lights captured by the front camera 2 from the front camera 2. Further, the acquisition part 231 acquires data of the driver monitor camera image including the face of the driver of the host vehicle 1 captured by the driver monitor camera 7 from the driver monitor camera 7. Furthermore, the acquisition part 231 acquires information showing a positional relationship of the front camera 2 and the driver monitor camera 7 from for example the memory 22.

The gaze position identifying part 232 identifies a driver gaze position G2P that is a position on the front camera image G2 captured by the front camera 2 corresponding to a position in front of the host vehicle 1 which the driver of the host vehicle 1 is gazing at based on the positional relationship between the driver monitor camera 7 and the front camera 2 and a driver monitor camera image including the face of the driver of the host vehicle 1 captured by the driver monitor camera 7. The gaze position identifying part 232 uses, for example, the art described in Japanese Patent No. 6459856, paragraph 0018, paragraph 0019, etc. to identify the driver gaze position G2P on the front camera image G2.

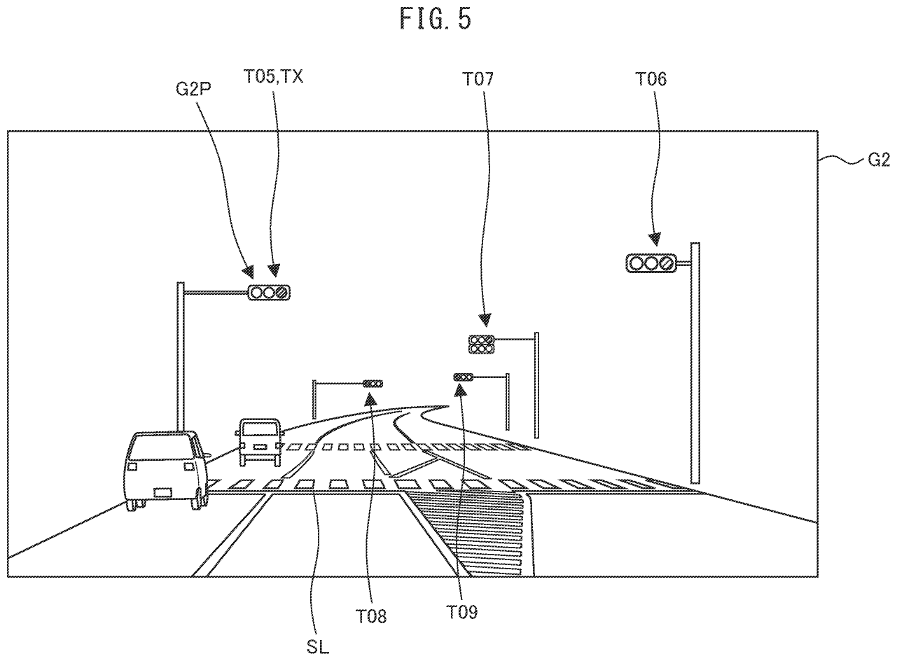

FIG. 5 is a view showing one example of the driver gaze position G2P on the front camera image G2 identified by the gaze position identifying part 232.

In the example shown in FIG. 5, five traffic lights T05 to T09 are included in the front camera image G2. The traffic light T05, the traffic light T06, and the traffic light T07 display red lights while the traffic light T08 and the traffic light T09 display blue lights (or green lights.) The traffic light T05 and the traffic light T06 among the five traffic lights T05 to T09 are traffic lights which the host vehicle 1 should obey. The state shown in FIG. 5 is a state where the host vehicle 1 has to stop before the stop line SL (lower side of FIG. 5) in accordance with the traffic light T05 or the traffic light T06 displaying red lights. That is, the traffic light T07, the traffic light T08, and the traffic light T09 are traffic lights installed at intersections which are different from the intersection at which the traffic light T05 and the traffic light T06 are installed (that is, the intersection which the host vehicle 1 is trying to pass) and which the host vehicle 1 should not obey.

In the example shown in FIG. 5, the driver of the host vehicle 1 is gazing at the red light displayed by the traffic light T05 and makes the host vehicle 1 stop before the stop line SL in accordance with that red light. For this reason, the gaze position identifying part 232 identifies the driver gaze position G2P on the front camera image G2 captured by the front camera 2 corresponding to the position in front of the host vehicle 1 gazed at by the driver of the host vehicle 1 (in more detail, the position of the traffic light T05) based on the positional relationship between the driver monitor camera 7 and the front camera 2 and the driver monitor camera image including the face of the driver of the host vehicle 1 captured by the driver monitor camera 7.

In the example shown in FIGS. 1 to 3, the traffic light detection part 233 detects the traffic lights included in the front camera image G2 captured by the front camera 2. The traffic light detection part 233 uses, for example, technology described in Japanese Patent No. 7073880, paragraph 0022, etc. to detect the traffic lights included in the front camera image G2.

The traffic light identification part 234 for the host vehicle 1 identifies the traffic light TX for the host vehicle 1 that is the traffic light which the host vehicle 1 should obey among the plurality of traffic lights T01 to T04 (see FIG. 4) when the plurality of traffic lights T01 to T04 included in the front camera image G2 are detected by the traffic light detection part 233. In more detail, the traffic light identification part 234 for the host vehicle 1 uses the later explained technique to identify the traffic light TX for the host vehicle 1.

The intersection entry determination part 235 determines whether the host vehicle 1 is entering the intersection. In more detail, the intersection entry determination part 235 determines whether the host vehicle 1 is entering the intersection based on the positional information of the host vehicle 1 acquired by the GPS unit 5 and the map information held by the map information unit 6.

In another example, the intersection entry determination part 235 may use, for example, the technology described in Japanese Patent No. 7095638, paragraph 0068 to paragraph 0070, etc. to determine whether the host vehicle 1 is entering the intersection based on the front camera image G2 captured by the front camera 2.

In the example shown in FIGS. 1 to 3, the preceding vehicle determination part 236 determines whether the preceding vehicle exists in front of the host vehicle 1 (in more detail, the preceding vehicle positioned between the host vehicle 1 and the intersection and running in the same lane as the lane in which the host vehicle 1 is running). The preceding vehicle determination part 236 determines whether the preceding vehicle exists in front of the host vehicle 1 based on the front camera image G2 captured by the front camera 2 and the detection result of the radar 3 in the same way as, for example, the technology described in Japanese Patent No. 7176467, paragraph 0043.

In another example, the preceding vehicle determination part 236 may determine whether the preceding vehicle exists in front of the host vehicle 1 based on only the detection result of the radar 3.

In the example shown in FIGS. 1 to 3, the braking operation detection part 237 detects a braking operation by the driver of the host vehicle 1. In more detail, the braking operation detection part 237 detects the braking operation by the driver of the host vehicle 1 based on an output signal of the brake switch 9 (that is, a signal showing whether the brake pedal is being operated by the driver of the host vehicle 1).

In another example, the braking operation detection part 237 may detect the braking operation by the driver of the host vehicle 1 based on, for example, the detection result of a master cylinder pressure sensor (not shown) or the like.

In the example shown in FIGS. 1 to 3, the traffic light identification part 234 for the host vehicle 1 identifies the traffic light T-5 existing at the driver gaze position G2P among the plurality of traffic lights T05 to T09 included in for example the front camera image G2 shown in FIG. 5 as the traffic light TX for the host vehicle 1, when the preceding vehicle determination part 236 determines that the preceding vehicle does not exist in front of the host vehicle 1, when the intersection entry determination part 235 determines that the host vehicle 1 is entering the intersection, and when the braking operation detection part 237 detects the braking operation by the driver of the host vehicle 1. This is because the driver of the host vehicle 1 starts the braking operation after visually recognizing the red light of the traffic light TX for the host vehicle 1 and makes the host vehicle 1 stop before the stop line SL.

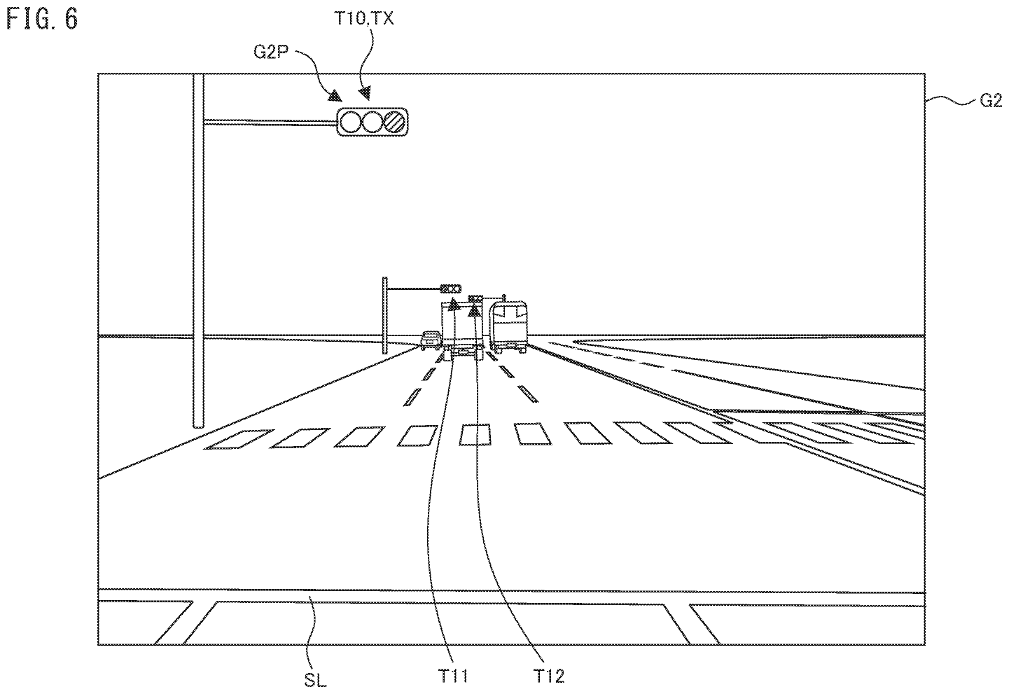

FIG. 6 is a view showing another example of the driver gaze position G2P on the front camera image G2 identified by the gaze position identifying part 232.

In the example shown in FIG. 6, three traffic lights T10 to T12 are included in the front camera image G2. The traffic light T10 displays the red light while the traffic light T11 and the traffic light T12 display blue lights (of green lights.) The traffic light T10 among the three traffic lights T10 to T12 is a traffic light which the host vehicle 1 should obey. The state shown in FIG. 6 is a state where the host vehicle 1 has to stop before the stop line SL (lower side of FIG. 6) in accordance with the traffic light T10 displaying the red light. That is, the traffic light T11 and the traffic light T12 are traffic lights installed at intersections different from the intersection at which the traffic light T10 is installed (that is, the intersection which the host vehicle 1 is trying to pass) and which the host vehicle 1 should not obey.

In the example shown in FIG. 6, the driver of the host vehicle 1 is gazing at the red light displayed by the traffic light T10 and trying to make the host vehicle 1 stop at before the stop line SL in accordance with the red light. For this reason, the gaze position identifying part 232 identifies the driver gaze position G2P on the front camera image G2 captured by the front camera 2 corresponding to the position in front of the host vehicle 1 gazed at by the driver of the host vehicle 1 (in more detail, the position of the traffic light T10) based on the positional relationship between the driver monitor camera 7 and the front camera 2 and the driver monitor camera image including the face of the driver of the host vehicle 1 captured by the driver monitor camera 7.

In the example shown in FIG. 6, the intersection entry determination part 235 determines that the host vehicle 1 is entering the intersection at which the traffic light T10 is installed. Further, the preceding vehicle determination part 236 determines that the preceding vehicle (in more detail, the preceding vehicle positioned between the host vehicle 1 and the intersection at which the traffic light T10 is installed and running in the same lane as the lane in which the host vehicle 1 is running) does not exist in front of the host vehicle 1. Further, the braking operation detection part 237 detects the braking operation by the driver of the host vehicle 1. As a result, the traffic light identification part 234 for the host vehicle 1 identifies the traffic light T10 existing at the driver gaze position G2P among the plurality of traffic lights T10 to T12 included in the front camera image G2 shown in FIG. 6 as the traffic light TX for the host vehicle 1.

In the example shown in FIGS. 1 to 3, the warning device 30 is configured by a microcomputer provided with communication interface 31, memory 32, and processor 33. The communication interface 31, the memory 32, and the processor 33 are connected through signal lines 34. The communication interface 31 has an interface circuit for connecting the warning device 30 to the internal vehicle network 13. The memory 32 stores programs used in processing performed by the processor 33 and various types of data. The processor 23 has the function of reporting to the driver of the host vehicle 1 the change of a display of the traffic light TX for the host vehicle 1 included in the front camera image G2 from the red light to the blue light (or green light) and the like.

The processor 33 has a function as a light determination part 331, a function as an accelerator pedal determination part 332, and a function as a control part 333.

The light determination part 331 determines whether the display of the traffic light TX for the host vehicle 1 included in the front camera image G2 changed from the red light to the blue light (or green light.) The light determination part 331 uses, for example, the art described in U.S. Patent Publication No. 2013/0253754, the art described in Japanese Patent No. 7180565, paragraph 0057 or the like so as to determine whether the display of the traffic light TX for the host vehicle 1 included in the front camera image G2 changed from the red light to the blue light (or green light.)

The accelerator pedal determination part 332 determines whether the driver of the host vehicle 1 depressed the accelerator pedal before a predetermined time elapses from the time point when the display of the traffic light TX for the host vehicle 1 included in the front camera image G2 changed from the red light to the blue light (or green light.) In more detail, the accelerator pedal determination part 332 determines whether the driver of the host vehicle 1 depressed the accelerator pedal based on the detection result of the accelerator pedal sensor 10.

The control part 333 performs processing for making the HMI 8 output a warning prompting the driver of the host vehicle 1 to start the host vehicle 1 when the driver of the host vehicle 1 did not depress the accelerator pedal before a predetermined time elapses from the time point when the display of the traffic light TX for the host vehicle 1 included in the front camera image G2 changed from the red light to the blue light (or green light.)

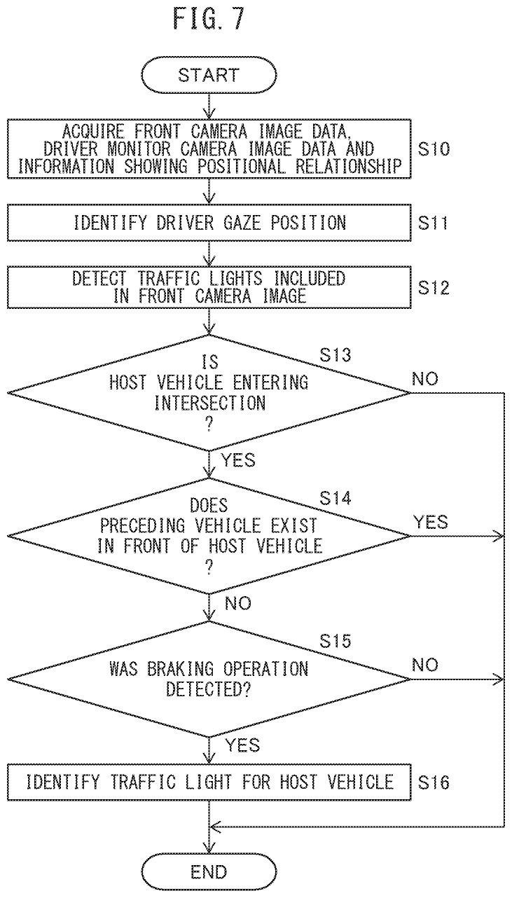

FIG. 7 is a flow chart for explaining one example of processing performed by the processor 23 of the traffic light identification device 20 for the host vehicle 1 of the first embodiment.

In the example shown in FIG. 7, at step S10, the acquisition part 231 acquires the data of the front camera image G2, the data of the driver monitor camera image, and the information showing the positional relationship between the front camera 2 and the driver monitor camera 7.

At step S11, the gaze position identifying part 232 identifies the driver gaze position G2P that is the position on the front camera image G2 captured by the front camera 2 corresponding to the position in front of the host vehicle 1 which the driver of the host vehicle 1 is gazing at based on the positional relationship between the front camera 2 and the driver monitor camera 7 and the driver monitor camera image.

At step S12, the traffic light detection part 233 detects the traffic lights included in the front camera image G2.

At step S13, the intersection entry determination part 235 determines whether the host vehicle 1 is entering the intersection. If YES, the routine proceeds to step S14, while if NO, the routine shown in FIG. 7 is ended.

At step S14, the preceding vehicle determination part 236 determines whether the preceding vehicle exists in front of the host vehicle 1. If NO, the routine proceeds to step S15, while if YES, the routine shown in FIG. 7 is ended.

At step S15, for example, the traffic light identification part 234 for the host vehicle 1 determines whether the braking operation detection part 237 detected the braking operation by the driver of the host vehicle 1. If YES, the routine proceeds to step S16, while if NO, the routine shown in FIG. 7 is ended.

At step S16, the traffic light identification part 234 for the host vehicle 1 identifies the traffic light TX for the host vehicle 1 which the host vehicle 1 should obey among the traffic lights included in the front camera image G2 detected at step S12. In more detail, the traffic light identification part 234 for the host vehicle 1 identifies the traffic light existing at the driver gaze position G2P on the front camera image G2 identified at step S11 among the traffic lights included in the front camera image G2 detected at step S12 as the traffic light TX for the host vehicle 1.

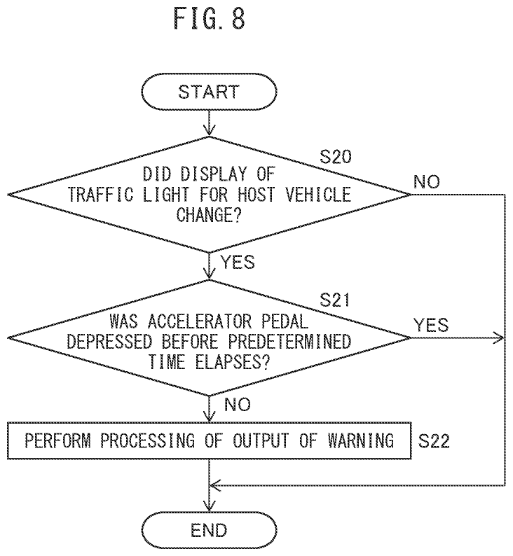

FIG. 8 is a flow chart for explaining one example of processing performed by the processor 33 of the warning device 30 shown in FIG. 3.

In the example shown in FIG. 8, at step S20, the light determination part 331 determines whether the display of the traffic light TX for the host vehicle 1 included in the front camera image G2 changed from the red light to the blue light (or green light.) If YES, the routine proceeds to step S21, while if NO, the routine shown in FIG. 8 is ended.

At step S21, the accelerator pedal determination part 332 determines whether the driver of the host vehicle 1 depressed the accelerator pedal before the predetermined time elapses from the time point when the display of the traffic light TX for the host vehicle 1 included in the front camera image G2 changed from the red light to the blue light (or green light.) If NO, the routine proceeds to step S22, while if YES, the routine shown in FIG. 8 is ended.

At step S22, the control part 333 performs the processing for making the HMI 8 output the warning prompting the driver of the host vehicle 1 to start the host vehicle 1.

### <Second Embodiment>

The host vehicle 1 to which the traffic light identification device 20 for the host vehicle 1 of the second embodiment is applied is configured in the same way as the host vehicle 1 to which the traffic light identification device 20 for the host vehicle 1 of the first embodiment is applied shown in FIG. 1 except for the points explained later. Further, the traffic light identification device 20 for the host vehicle 1 of the second embodiment is configured in the same way as the traffic light identification device 20 for the host vehicle 1 of the first embodiment shown in FIG. 2.

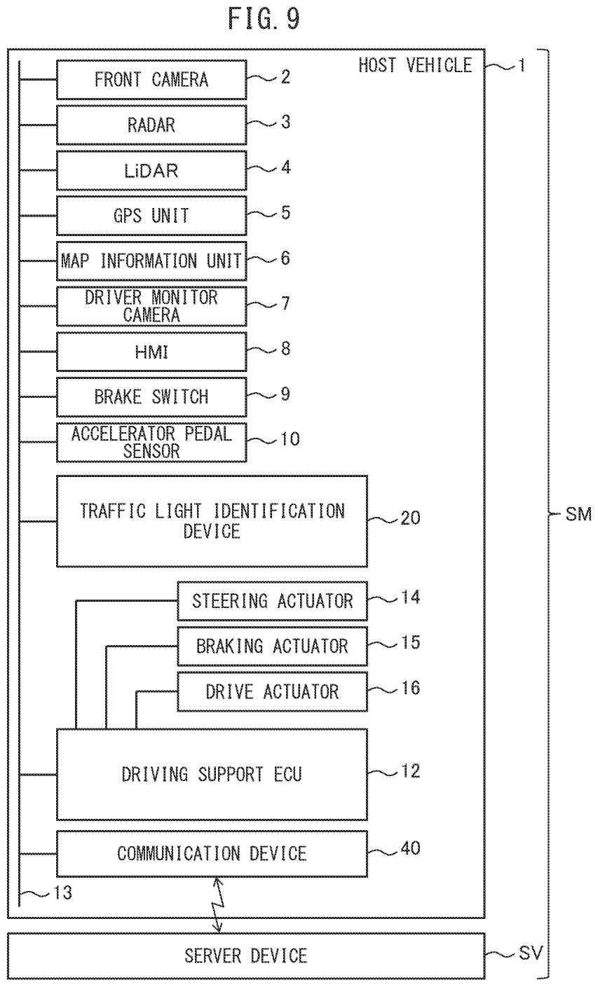

FIG. 9 is a view showing one example of a data collection system SM including the host vehicle 1 to which the traffic light identification device 20 for the host vehicle 1 of the second embodiment is applied and a server device SV.

As explained above, in the example shown in FIG. 1, the host vehicle 1 is provided with the warning device 30.

On the other hand, in the example shown in FIG. 9, the host vehicle 1 is not provided with the warning device 30 but is provided with a communication device 40. The communication device 40 is, for example, comprised of a DCM (data communication module). The communication device 40 has the function of sending the data of the front camera image G2 including the plurality of traffic lights captured by the front camera 2 to the server device SV. Further, the communication device 40 has the function of sending the information showing the traffic light TX for the host vehicle 1 included in the front camera image G2 identified by the traffic light identification part 234 for the host vehicle 1 to the server device SV.

In the example shown in FIG. 9, the server device SV is comprised of a computer having, for example, a CPU (central processing unit), a memory, a storage, a NIC (network interface card) and the like. The server device SV is provided with a communication part (not shown), a storage part (not shown), and a control part (not shown).

For example, the NIC functions as the communication part of the server device SV. The communication part of the server device SV receives the data of the front camera image G2 and the information showing the traffic light TX for the host vehicle 1 included in the front camera image G2 sent by the communication device 40 of the host vehicle 1.

A memory such as a RAM (random access memory), a ROM (read only memory) and the like and a storage such as an HDD, an SSD or the like function as the storage part of the server device SV. The storage part of the server device SV stores the data of the front camera image G2 and the information showing the traffic light TX for the host vehicle 1 included in the front camera image G2 received by the communication part of the server device SV.

For example, the CPU functions as the control part of the server device SV. The control part of the server device SV, for example, performs processing for making the communication part of the server device SV receive the data of the front camera image G2 sent by the communication device 40 of the host vehicle 1 and the information showing the traffic light TX for the host vehicle 1 included in the front camera image G2 and processing for making the storage part of the server device SV store the data of the front camera image G2 received by the communication part of the server device SV and the information showing the traffic light TX for the host vehicle 1 included in the front camera image G2.

Further, the control part of the server device SV performs machine learning of a machine learning model for estimating a traffic light for an autonomous vehicle (not shown) that is a traffic light which is included in an image captured by a front camera (not shown) mounted on the autonomous vehicle and which the autonomous vehicle should obey. The data of the front camera image G2 and the information showing the traffic light TX for the host vehicle 1 included in the front camera image G2 sent by the communication device 40 of the host vehicle 1 and received by the communication part of the server device SV are used as correct answer data in the machine learning of the machine learning model.

As explained above, in the example shown in FIGS. 1 to 3, when the driver of the host vehicle 1 is gazing at the red light displayed by the traffic light and makes the host vehicle 1 stop before the stop line in accordance with the red light, the gaze position identifying part 232 identifies the driver gaze position G2P on the front camera image G2 captured by the front camera 2 corresponding to the position in front of the host vehicle 1 gazed at by the driver of the host vehicle 1 (in more detail, the position of the traffic light displaying the red light) based on the positional relationship between the driver monitor camera 7 and the front camera 2 and the driver monitor camera image including the face of the driver of the host vehicle 1 captured by the driver monitor camera 7.

In the example shown in FIG. 9, the gaze position identifying part 232, in the same way as the example shown in FIGS. 1 to 3, identifies the driver gaze position G2P on the front camera image G2 captured by the front camera 2 when the driver of the host vehicle 1 is gazing at the red light displayed by the traffic light and makes the host vehicle 1 stop before the stop line in accordance with the red light. Furthermore, the communication device 40 of the host vehicle 1 sends the data of the front camera image G2 captured by the front camera 2 and the information showing the traffic light TX for the host vehicle 1 included in the front camera image G2 (traffic light displaying the red light and existing at the driver gaze position G2P on the front camera image G2) to the server device SV as the correct answer data used for the machine learning of the machine learning model.

Further, in the example shown in FIG. 9, the gaze position identifying part 232 identifies the driver gaze position G2P on the front camera image G2 captured by the front camera 2, when the driver of the host vehicle 1 gazes at the green light (blue light) which the traffic light displays and restarts the host vehicle 1 in accordance with the green light (blue light) after the signal of the traffic light changes from the red light to the green light (blue light.) Furthermore, the communication device 40 of the host vehicle 1 sends the data of the front camera image G2 captured by the front camera 2 and the information showing the traffic light TX for the host vehicle 1 included in the front camera image G2 (traffic light displaying the green light (blue light) and existing at the driver gaze position G2P on the front camera image G2) to the server device SV as the correct answer data used for the machine learning of the machine learning model.

As background of the traffic light identification device 20 for the host vehicle 1 of the first and second embodiments, application of autonomous driving (driving support) technology to general roads in which there are intersections including traffic lights is sought. A driver of a vehicle makes his vehicle stop at an intersection in accordance with a red light and restarts the vehicle after the red light changes to a green light (blue light.) To realize application of autonomous driving technology to a general road, technology for identifying a traffic light which a host vehicle should obey among a plurality of traffic lights included in the front camera image captured by a front camera mounted on the host vehicle is necessary. In more detail, to realize application of autonomous driving technology to a general road, technology for identifying a traffic light which a host vehicle should obey using only the front camera image captured by a front camera mounted on the host vehicle (that is, without having to use positional information of the host vehicle etc.) is required.

To perform the machine learning of the machine learning model for estimating a traffic light which is included in an image captured by a front camera (not shown) mounted on an autonomous vehicle (not shown) and which the autonomous vehicle should obey, a vast amount of correct answer data is necessary.

Further, if a traffic light which a host vehicle should obey is, for example, a traffic light of a road end such as in Europe, a uniquely regional traffic light of a local government body, or other such unique traffic light, the work of using only the front camera image captured by a front camera mounted on the host vehicle to identify a traffic light which the host vehicle should obey and preparing correct answer data becomes difficult for an annotator and an increase in the work cost of the annotator is projected.

As explained above, in the host vehicle 1 provided with the traffic light identification device 20 for the host vehicle 1 of the second embodiment, when the front camera image G2 is captured by the front camera 2 and the front camera image G2 includes a plurality of traffic lights, the traffic light TX for the host vehicle 1 which the host vehicle 1 should obey among the plurality of traffic lights included in the front camera image G2 is identified by the traffic light identification part 234 for the host vehicle 1. That is, processing for identifying the traffic light

TX for the host vehicle 1 which is difficult for the annotator is performed by the traffic light identification part 234 for the host vehicle 1. For this reason, by using the traffic light identification device 20 for the host vehicle 1 of the second embodiment, it is possible to improve the applicability of autonomous driving technology to general roads where intersections including traffic lights are present.

Further, as explained above, in the host vehicle 1 provided with the traffic light identification device 20 for the host vehicle 1 of the first embodiment as well, when the front camera image G2 is captured by the front camera 2 and the front camera image G2 includes a plurality of traffic lights, the traffic light TX for the host vehicle 1 which the host vehicle 1 should obey among the plurality of traffic lights included in the front camera image G2 is identified by the traffic light identification part 234 for the host vehicle 1. For this reason, in the host vehicle 1 provided with the traffic light identification device 20 for the host vehicle 1 of the first embodiment, when the signal of the traffic light TX for the host vehicle 1 changes from the red light to the blue light (or green light), the driver of the host vehicle 1 can be prompted to start the host vehicle 1 based on the front camera image G2 including the traffic light TX for the host vehicle 1.

In the above way, embodiments of the traffic light identification device for the host vehicle, the host vehicle, the traffic light identification method for the host vehicle, and the non-transitory recording medium of the present disclosure were explained with reference to the drawings, but the traffic light identification device for the host vehicle, the host vehicle, the traffic light identification method for the host vehicle, and the non-transitory recording medium of the present disclosure are not limited to the embodiments explained above. It is possible to make suitable changes within a range not deviating from the gist of the present disclosure. The configurations of the examples of the above embodiments may be suitably combined.

In each of the above embodiments, the processing performed by the traffic light identification device 20 for the host vehicle 1 was explained as software processing performed by running the program stored in the memory 22, but the processing performed by the traffic light identification device 20 for the host vehicle 1 may also be processing performed by hardware. Alternatively, the processing performed in the traffic light identification device 20 for the host vehicle 1 may be processing combining both software and hardware. Further, the program stored in the memory 22 of the traffic light identification device 20 for the host vehicle 1 (program for realizing the function of the processor 23 of the traffic light identification device 20 for the host vehicle 1), for example, may be recorded in a computer readable recording 10 medium such as a semiconductor memory, magnetic recording medium, optical recording medium (non-transitory recording medium), etc. and supplied, distributed, etc.

1. A traffic light identification device for a host vehicle comprising a processor configured to:
identify a driver gaze position that is a position on a front camera image captured by a front camera corresponding to a position in front of the host vehicle which a driver of the host vehicle is gazing at based on a positional relationship between a driver monitor camera and the front camera and a driver monitor camera image including a face of the driver captured by the driver monitor camera;
detect at least one traffic light included in the front camera image;
identify a traffic light for the host vehicle that is a traffic light which the host vehicle should obey among a plurality of traffic lights when the plurality of traffic lights included in the front camera image is detected;
determine whether the host vehicle is entering an intersection;
determine whether a preceding vehicle exists in front of the host vehicle; and
detect a braking operation by the driver,
wherein the processor identifies a traffic light existing at the driver gaze position among the plurality of traffic lights included in the front camera image as the traffic light for the host vehicle, when the preceding vehicle does not exist in front of the host vehicle, when the host vehicle is entering the intersection, and when the braking operation by the driver is detected.

2. The host vehicle comprising the traffic light identification device for the host vehicle according to claim 1 and a warning device, wherein a processor provided in the warning device is configured to:
determine whether a display of the traffic light for the host vehicle changed from a red light to a blue light or a green light;
determine whether the driver depressed an accelerator pedal before a predetermined time elapses from the time point when the display of the traffic light for the host vehicle changed from the red light to the blue light or the green light; and
perform processing for outputting a warning when the driver did not depress the accelerator pedal before the predetermined time elapses from the time point when the display of the traffic light for the host vehicle changed from the red light to the blue light or the green light.

3. The host vehicle comprising the traffic light identification device for the host vehicle according to claim 1 and a communication device, wherein
the communication device is configured to send data of the front camera image and information showing the traffic light for the host vehicle included in the front camera image identified by the processor of the traffic light identification device for the host vehicle to a server device, the
server device is configured to perform machine learning of a machine learning model for estimating a traffic light for an autonomous vehicle that is a traffic light which is included in an image captured by a front camera mounted on the autonomous vehicle and which the autonomous vehicle should obey, and
the data of the front camera image sent by the communication device and the information showing the traffic light for the host vehicle included in the front camera image identified by the processor of the traffic light identification device for the host vehicle are used as correct answer data in the machine learning of the machine learning model.

4. A traffic light identification method for a host vehicle comprising:
identifying a driver gaze position that is a position on a front camera image captured by a front camera corresponding to a position in front of the host vehicle which a driver of the host vehicle is gazing at based on a positional relationship between a driver monitor camera and the front camera and a driver monitor camera image including a face of the driver captured by the driver monitor camera;
detecting at least one traffic light included in the front camera image;
identifying a traffic light for the host vehicle that is a traffic light which the host vehicle should obey among a plurality of traffic lights when the plurality of traffic lights included in the front camera image is detected;
determining whether the host vehicle is entering an intersection;
determining whether a preceding vehicle exists in front of the host vehicle; and
detecting a braking operation by the driver,
wherein a traffic light existing at the driver gaze position among the plurality of traffic lights included in the front camera image is identified as the traffic light for the host vehicle, when the preceding vehicle does not exist in front of the host vehicle, when the host vehicle is entering the intersection, and when the braking operation by the driver is detected.

5. A non-transitory recording medium having recorded thereon a computer program for causing a processor to execute a process comprising:
identifying a driver gaze position that is a position on a front camera image captured by a front camera corresponding to a position in front of a host vehicle which a driver of the host vehicle is gazing at based on a positional relationship between a driver monitor camera and the front camera and a driver monitor camera image including a face of the driver captured by the driver monitor camera;
detecting at least one traffic light included in the front camera image;
identifying a traffic light for the host vehicle that is a traffic light which the host vehicle should obey among a plurality of traffic lights when the plurality of traffic lights included in the front camera image is detected;
determining whether the host vehicle is entering an intersection;
determining whether a preceding vehicle exists in front of the host vehicle; and
detecting a braking operation by the driver,
wherein a traffic light existing at the driver gaze position among the plurality of traffic lights included in the front camera image is identified as the traffic light for the host vehicle, when the preceding vehicle does not exist in front of the host vehicle, when the host vehicle is entering the intersection, and when the braking operation by the driver is detected.
